(19) United States
(12) Patent Application Publication
(10) Pub. No.: US 2024/0180190 A1
(43) Pub. Date: Jun. 6, 2024

(54) METHODS OF EGG YOLK FRACTIONATION

(71) Applicant: Michael Foods, Inc., Minnetonka, MN (US)

(72) Inventors: Noel G. RUDIE, Gaylord, MN (US); Alicia STUBE, Gaylord, MN (US); Daniel VANCE, Gaylord, MN (US)

(21) Appl. No.: 18/440,185

(22) Filed: Feb. 13, 2024

Related U.S. Application Data
(63) Continuation of application No. 16/626,562, filed on Dec. 25, 2019.
(60) Provisional application No. 62/525,132, filed on Jun. 26, 2017.

(51) Int. Cl. A23J 1/08

(52) U.S. Cl. CPC A23J 1/08

(57) ABSTRACT

Liquid egg yolk can be fractionated into water soluble and precipitated lipophilic fractions without the need to freeze or add carbohydrate(s). A composition that includes egg yolk and an excess of water has its pH downwardly adjusted before being gravitationally separated into low and high density fractions, with the former including no more than 5% of the granules from the egg yolk.

### CROSS-REFERENCE TO RELATED APPLICATIONS

This application is a continuation of U.S. application Ser. No. 16/626,562, filed Dec. 25, 2019, which is a national phase under 35 U.S.C. § 371 of International Application No. PCT/US2018/039190, filed Jun. 24, 2018, which claims the benefit of priority to U.S. Provisional Patent Application Ser. No. 62/525,132, filed Jun. 26, 2017, the entire contents of each of which are hereby incorporated by reference in their entirety.

### BACKGROUND INFORMATION

Avian eggs, particularly hen eggs, have been a food staple for centuries. Over time, different uses have manifested for egg whites and egg yolks.

Egg yolk involves supramolecular assemblies of lipids and proteins, due in large part to interactions between proteins and phospholipids.

Egg yolk includes two fractions: plasma (about two-thirds of the yolk) and granules (about one-third of the yolk). These fractions differ compositionally, with each possessing structures and functionalities that differ from those of the other. Plasma contains a large quantity of lipids structured as lipoproteins (low-density lipoproteins), whereas granules are mainly composed of proteins aggregated in micrometric assemblies.

In recent years, efforts at separating egg yolks into its constituent components have grown. These fractions have distinct physicochemical properties such as solubility (with the granules being poorly soluble in water, whereas the plasma has good solubility), ability to act as an emulsifier, and tendency to gel.

In addition to opening the possibility of individual components being used in the manufacture of non-food products, fractionation also opens the possibility of providing food products with reduced amounts of fat and cholesterol. Low cholesterol products can be made using the protein-rich, low-fat granule fraction as a substitute for egg yolk.

The plasma portion also contains valuable subcomponents such as, for example, immunoglobulin Y (IgY) and transfer factors. The presence of even a small amount of granules in the plasma portion greatly complicates the isolation of such valuable subcomponents. Separating the granule and plasma portions of egg yolk typically involves at least one of a freezing step and addition of a carbohydrate such as an alginate.

That which remains desirable is an efficient, commercial scale process for fractionating egg yolk into its plasma- and granule-rich components which does not involve a time- and energy-intensive step, such as freezing, or the addition of a non-native nutritional additive such as a carbohydrate. Particularly desirable is such a process that can be operated in a semi-batch or even continuous manner.

### SUMMARY

Hereinafter is described a method for fractionating liquid egg yolk into water soluble and precipitated lipophilic fractions. Without the need for a freezing step and/or addition of a carbohydrate such as an alginate, the egg yolk granules can be concentrated in the precipitated lipophilic fraction so that the water soluble fraction includes no more than 5% (w/w) of the granules.

To a composition that includes egg yolk and an excess of water is added a food grade acid, resulting in the pH of the composition being downwardly adjusted to 4≤pH≤6. The pH-adjusted composition is gravitationally separated into water soluble and precipitated lipophilic fractions. The method can be performed at non-elevated temperatures, i.e., at or below ambient temperature. The water soluble fraction of the fractionated egg yolk contains no more than 5%, and preferably less than 5%, of the granules from the egg yolk.

The composition includes at least as much water as egg yolk by volume and, in some embodiments, significantly more. Separational efficiency considerations argue for keeping this excess toward the lower end of the range.

The water component of the composition preferably has a low concentration of dissolved metal ions, preferably 100 ppm or below.

The fractionation process typically is performed at or below ambient temperatures yet, as mentioned above, freezing of the water-yolk composition is avoided.

Advantageously, the water soluble and precipitated lipophilic fractions are provided in a manner in which each is amenable to further processing by which the constituent components of each can be concentrated and/or isolated. By way of non-limiting example, this includes provision of a water soluble (low density) fraction which can be further processed so as to yield a relatively pure version of IgY.

Unless a portion of text specifically indicates otherwise, all percentages throughout this document are weight percentages, i.e., w/w.

The more detailed description that follows provides additional details which explain and exemplify the aforedescribed processes. The appended claims define the inventions in which exclusive rights are claimed, and they are not intended to be limited to particular embodiments shown and described, from which ordinarily skilled artisans can envision variations and additional aspects.

### DETAILED DESCRIPTION OF ILLUSTRATIVE EMBODIMENTS

None of the steps involved in the processes summarily described above need to be conducted at supra-ambient temperatures. The entireties of the processes are conducted such that the liquids involved do not encounter temperatures of 0° C. or less and no more than the temperature at which egg yolk proteins begin to coagulate, i.e., ˜60° C. In most embodiments, each step of the method is conducted at a temperature of no more than ˜50° C., no more than ˜45° C., and even no more than ˜40° C.; an exemplary maximum temperature is ˜37° C. Generally, the processes are performed so that the liquids encounter no temperatures outside the range of 0° to 35° C., with preferred maximum temperatures being on the order of no more than 30° C., no more than 27.5ºC, no more than 25° C., no more than 22.5ºC, no more than 20° C., and even no more than 15° C. Food safety considerations typically argue for conducting the process at or near refrigerated temperatures, e.g., ˜0.5° to 5° C.

The processes employ a composition that includes egg yolk and water.

Because the process is scalable, being limited only by the size of equipment available and structures in which to house or shelter such equipment, the amounts of each component are described herein in terms of relative volumes. Although any amount of composition can be employed in the process, operational efficiencies argue for usage of quantities measured on the scale of at least liters and preferably decaliters, hectoliters, or even megaliters.

The composition includes at least as much water (by volume) as egg yolk and often includes an excess of water. Generally, the volume ratio of water to egg yolk ranges from 1:1 to 10:1, with exemplary ratios including 10:9, 8:7, 5:4, 4:3, 3:2, 2:1, 5:2, 3:1, 8:3, 7:2, 4:1, 9:2, 5:1, 6:1 and 7:1. (Also contemplated are ranges defined by combinations of two of the foregoing ratios.) Operational efficiencies typically are achieved by keeping the excess of water as close as possible to the 2× lower limit.

The egg yolk employed in the composition can be liquid from a whole egg, preferably from hen eggs, or reconstituted. If the latter is employed directly, the amount of water employed in the composition must be upwardly adjusted by an appropriate amount to account for reconstitution. Alternatively, reconstitution can be done prior to introducing the egg yolk component into the composition, with such reconstitution being performed in the vessel employed for the mixing step (described below) or in a separate vessel from which the reconstituted egg yolk is pumped or otherwise transferred to the mixing vessel. In another embodiment, reconstitution can occur in a semi-batch or continuous manner by combining separate streams of appropriately metered amounts of dried egg yolk and water.

Although pasteurized egg yolk can be employed, the egg yolk preferably is not pasteurized, homogenized, or previously processed in a high shear mixture. Raw hen egg yolk is preferred.

Some sources of water might be sufficiently pure to permit usage of water from a nearby well or water treatment facility. Use of purified water (e.g., deionized or distilled) is preferred in those areas having water that contains significant amounts of alkali, alkali earth, or transition metal ions, however. The water component of the composition preferably has a metal ion concentration of no more than 250 ppm, preferably no more than 125 ppm, more preferably no more than 75 ppm, even more preferably no more than 50 ppm, and most preferably no more than 25 ppm.

Again, water can be added to the vessel employed for the mixing step (described below) in a batch, semi-batch or continuous manner, depending on the available equipment.

The composition typically is mixed or otherwise gently agitated so as to be macroscopically homogenous. Natural emulsifiers in egg yolk permit the hydrophobic subcomponents to mix well with the excess of water.

Unless the water source employed is unusually acidic, the egg yolk-water mixture generally will be only slightly acidic. Prior to the gravitational separation process described below, the pH of the composition is downwardly adjusted by addition of food grade acid. This can be done by addition of the acid to the agitated mixture, vice versa, or a combination, i.e., addition of the egg yolk-water mixture to a mixing vessel already containing some acid followed by sufficient additional acid to bring the adjusted mixture down to the targeted pH. In processes conducted in a semi-batch or continuous fashion, acid can be delivered in aliquots, discontinuous stream or continuous stream. Additionally, the acid can be added as a solid (typically in powder form) or diluted in water to provide an acid solution.

Potentially useful acids include strong acids, such as HCl and H₂SO₄, and weak acids including, but not limited to, phosphoric acid and any of a variety of carboxylic acids such as citric, malic, propanoic, sorbic and acetic acids.

Sufficient acid is added to provide a composition of from 4≤pH≤6, preferably from 4.5≤pH≤5.8, more preferably from 4.7≤pH≤5.7, and even more preferably from 5.0≤pH≤5.6. pH can be measured in a variety of ways including, for example, an appropriately calibrated pH sensor.

Operational efficiencies argue against significant mixing/agitation after the target pH is reached. Nevertheless, further mixing/agitation is not excluded from the process.

Upon the pH of the composition being downwardly adjusted, some or all of the composition (depending on the manner in which the process is conducted) is subjected to one or more gravitational separation techniques. Although the composition can be allowed to sit quiescently until fractionation occurs, operational considerations generally argue for employing mechanical means such as a clarifier, separator, decanter or centrifuge, with the latter being particularly preferred. In some embodiments, multiple centrifuging steps can be conducted in series. Depending on the gravitational force resulting from the mechanical devices employed, the amount of time involved in the separation step can range from a few seconds to several days, generally from 10 to 100,000 seconds, typically from 20 to 40,000 seconds, and most typically from 30 to 3000 seconds. In commercial scale applications, the gravitational separation step preferably takes no more than ˜60 seconds.

Advantageously, the separation into water soluble and precipitated lipophilic fractions requires neither a freezing step nor addition of a carbohydrate such as an alginate. For an example of a process employing a freezing step, the interested reader is directed to P. Hodek et al., “Optimized Protocol of Chicken Antibody (IgY) Purification Providing Electrophoretically Homogeneous Preparation,” Intl. J. Electochem. Sci., vol. 8, pp. 113-24 (2013). For an example of a process employing addition of a carbohydrate, see S. Hwee Tan et al, “A novel, cost-effective and efficient chicken egg IgY purification procedure,” J. Immunolog. Methods, vol. 380, pp. 73-76 (2012).

Regardless of the gravitational separation technique employed, the pH adjusted composition separates into water soluble and precipitated lipophilic fractions. The water soluble fraction is, in large part, lipoprotein-free (or at least substantially lipoprotein-free) plasma, while the precipitated lipophilic fraction includes the vast majority of the aforementioned granules. The separation is carried out such that no more than 5%, preferably no more than 4%, more preferably no more than 3%, even more preferably no more than 2%, and most preferably no more than ˜1% of the granules apportion into the water soluble fraction, thereby resulting in the vast majority, even substantially all, of such granules locating in the lipophilic fraction.

Each of the two fractions contains components which are commercially valuable and, advantageously, are present in forms which facilitate further processing and separation.

The foregoing description has employed certain terms and phrases for the sake of brevity, clarity, and ease of understanding; no unnecessary limitations are to be implied therefrom because such terms are used for descriptive purposes and are intended to be broadly construed. The relevant portion(s) of any patent or publication specifically mentioned in the foregoing description is or are incorporated herein by reference.

The foregoing compositions and methods have been presented by way of example only. Certain features of the described compositions and methods may have been described in connection with only one or a few such compositions or methods, but they should be considered as being useful in other such compositions or methods unless their structure or use is incapable of adaptation for such additional use. Also contemplated are combinations of features described in isolation.

1. A method for fractionating egg yolk into a water soluble fraction and a precipitated lipophilic fraction, the method comprising:
a) obtaining a pH-adjusted egg yolk composition having a pH of 4 to 6 by adding a food grade acid to a composition comprising egg yolk and water, wherein the composition comprising the egg yolk and the water comprises at least as much water as egg yolk by volume; and
b) gravitationally separating the pH-adjusted egg yolk composition into the water soluble fraction and the precipitated lipophilic fraction.

2. The method of claim 1, wherein step (b) is performed without freezing.

3. The method of claim 1, wherein step (b) is performed independent of a carbohydrate.

4. The method of claim 1, wherein the water soluble fraction includes less than 5% (w/w) of egg yolk granules.

5. The method of claim 1, wherein the egg yolk comprises raw egg yolk or reconstituted egg yolk.

6. The method of claim 1, wherein the composition comprises a volume of the water that is from 1 to less than 5 times a volume of the egg yolk.

7. The method of claim 1, wherein the composition comprises a volume of the water that is from 1 to 2 times a volume of the egg yolk.

8. The method of claim 1, wherein:
the composition comprises a volume of the water that is in excess of a volume of the egg yolk, and
the excess volume of the water is 2 times the volume of the egg yolk.

9. The method of claim 1, wherein a ratio of a volume of the water to a volume of the egg yolk is 3 to 1.

10. The method of claim 1, wherein the water has a metal ion concentration less than or equal to 250 ppm.

11. The method of claim 1, wherein the water has a metal ion concentration less than or equal to 50 ppm.

12. The method of claim 1, further comprising agitating the composition prior to and during the addition of food grade acid.

13. The method of claim 1, wherein the food grade acid decreases the pH of the composition to 5.0 to 5.6.

14. The method of claim 1, wherein steps (a) and (b) are performed at a temperature of from 0° ° C. to 60° C.

15. The method of claim 14, wherein steps (a) and (b) are performed at a temperature of less than or equal to 30° C.

16. The method of claim 14, wherein steps (a) and (b) are performed at a temperature of less than or equal to 25° C.

17. The method of claim 1, wherein the gravitational separation includes passive gravitational separation or mechanical gravitational separation using a clarifier, a separator, decanter, or centrifuge.

18. The method of claim 1, wherein step (b) is performed for 10 seconds to 100,000 seconds.

19. The method of claim 18, wherein step (b) is performed for less than or equal to 60 seconds.

20. A method for fractionating egg yolk into a water soluble fraction and a precipitated lipophilic fraction, the method comprising:
a) obtaining a pH-adjusted egg yolk composition having a pH of 4 to 6 by introducing a food grade acid to a diluted composition comprising egg yolk and water, wherein a volume of the water in the diluted composition is from 1 to less than 5 times a volume of the egg yolk; and
b) without freezing and independent of an added carbohydrate, gravitationally separating the pH-adjusted egg yolk composition into the water soluble fraction and the precipitated lipophilic fraction.
